(19) United States
(12) Patent Application Publication
(10) Pub. No.: US 2007/0286358 A1
(43) Pub. Date: Dec. 13, 2007

(54) Digital audio recorder

(75) Inventors: Itzhak Pomerantz, Kfar Saba (IL); Hagai Pomerantz, Kfar Saba (IL); Hadas Elkabir, Nahariya (IL)

Correspondence Address: MARK M. FRIEDMAN, C/O DISCOVEY DISPATCH , 9003 FLIRIN WAY, UPPER MARLBORO, MD, 20772, US

(73) Assignee: MSYSTEMS LTD.

(21) Appl. No.: 11/638,484

(22) Filed: Dec. 14, 2006

Related U.S. Application Data
(60) Provisional application No. 60/803,372, filed on May 29, 2006.

(51) Int. Cl. H04M 1/64

(52) U.S. Cl. 379/67.1

(57) ABSTRACT

An audio recording device includes a memory storing pre-recorded audio data that include a plurality of voice tags; a detector that is operative to produce a signal upon detection of a substantial similarity between a first portion of a statement spoken by a user and one of the voice tags; and a controller operative, in accordance with the signal produced by the detector, to store, in the memory, a second portion of the statement in association with the voice tag. In accordance with the scope of the invention, audio data may further include instruction commands, such that in response to a substantial similarity detected by the detector between a first portion of the statement and one of the instruction commands, the instruction command is applied in association with the second portion of the statement.

### CROSS-REFERENCE TO RELATED APPLICATIONS

This patent application claims the benefit of U.S. Provisional Patent Application No. 60/803,372 filed Apr. 29, 2006.

### FIELD OF THE INVENTION

The present invention relates generally to the field of digital audio recorders.

### BACKGROUND OF THE INVENTION

Portable Digital Audio Recorders (DAR) are well known in the art of electronics engineering, and are used for convenient recording, storing and retrieval of voice messages.

One of the main applications of DARs is recording user's verbal notes and reminding the user of such notes upon replay. As the nature of human memory is to be associative and spontaneous, people tend to “store” reminders in the routine of daily life in chronological order at random times and in random places. As an example, a person remembers to buy dishwasher powder, then he/she remembers to call the library, then he/she remembers to water the garden, and then he/she remembers to go see the “Girl with Umbrella” painting in the El Prado Museum at the next visit to Madrid.

A DAR known in the art is implemented as a sequential device to store such reminder notes in chronological order, so that the first reminder note dictated by a user is the first to be played to the user, the second reminder note dictated by the user is the second to be played to the user, etc.

However, the opportunities to carry out the reminded tasks do not necessarily present themselves in the order in which the reminders are stored, and are typically dependent on the user being in a specific location. For example, some reminder tasks can only be carried out in a grocery store. Other reminder tasks can only be carried out when the person visits his/her parents' home or in some other specific location, such as when in Madrid.

Existing devices are implemented to overcome this phenomenon, thereby enabling the user to store messages in different folders or files, which can be associated with typical locations, such as “office”, “home”, “Garage”, and so on. An example of such a DAR is the Panasonic RR-QR240 Digital Audio Recorder, available from NexTag, Inc., which records up to 99 files in each of five folders for a total of 495 files.

However, these existing devices are more cumbersome to operate than ordinary DARs known in the art. Existing devices require a display and several keys, thereby not enabling the user to press one button, state a message and be reminded of the message upon reaching the designated place. Furthermore, existing devices are programmed with a typically small and fixed number of folders.

Currently, existing techniques do not provide users, especially users with learning disabilities, a simple way to store and retrieve respective messages in association to a specific location or task. Therefore, most people continue to use paper notes for random reminders, and do not rely on the operation provided by existing DAR devices.

Thus, it would be useful to have an improved DAR enabling a user to sort verbal messages into a very large number of categories and to retrieve theses messages from a given category upon request in the appropriate place and/or at the relevant time, while not requiring speech-recognition capabilities.

### SUMMARY OF THE INVENTION

Accordingly, it is a principal object of the present invention to introduce a recording device implemented to store, in a memory, voice messages spoken by a user upon detecting a substantial similarity between a bounding portion of audio data received from the user and respective audio data previously stored in the memory.

Audio data refers herein to speech that is transformed into signals recognizable by a machine.

Note that in accordance with the present invention, the detection of a similarity between audio data received from the user and corresponding audio data previously stored in the memory requires utilizing pattern recognition methods only. Speech recognition is at all not required in the present invention, since there is no need to recognize what has been recorded by the user.

The term “substantial similarity” is defined herein to mean that a pattern of the previously recorded audio data and a pattern of at least a portion of a rendition of a statement as audio data are similar enough to be identified as being the same audio data segment by suitable pattern and voice recognition methods existing in the art.

The term “bounding portion of audio data” is defined herein to mean either the first syllable(s) (i.e. the prefix) or the last syllable(s) (i.e. the suffix) of a statement received from a user, and not an inner portion of the statement.

Preferably, the recording device of the present invention is further operative to manage audio data received from a user upon detecting a substantial similarity between a bounding portion of a statement received from a user and previously recorded audio data.

The managing of audio data includes, for example, retrieval of audio data (such as pending voice messages) from a respective folder, storage of audio data into a respective folder, creation of a new folder, deletion of voice messages from a respective folder, etc.

In accordance with the present invention, there is provided an audio recording device that includes: (a) a memory storing audio data that include a plurality of voice tags; (b) a detector operative to produce a signal upon detection of a substantial similarity between a first portion of a statement spoken by a user and one of the voice tags; and (c) a controller, operative in accordance with the signal produced by the detector, to store, in the memory, a second portion of the statement as audio data in association with this voice tag. Note that the first and second portions of the statement are defined to include any audio segment(s) of the statement, whether they are different audio segments, overlapping audio segments or the same audio segments.

Preferably, the second portion is a prefix and the first portion is a suffix. Alternatively, the second portion is a suffix and the first portion is a prefix. Optionally, at least one of the first portion and the second portion includes a middle portion of the statement.

Preferably, the controller, in accordance with the detector, is voice-operated.

Preferably, the audio data that are stored in the memory include instruction commands. Typical instruction commands include for example, a delete instruction, a new-folder instruction, a list instruction, etc. More preferably, in accordance with the detector, the controller is further operative to apply this one instruction command in association with the second portion of the statement.

Preferably, a list instruction is for initiating playing of at least some of the audio data in chronological order. The term “chronological order” is defined herein to mean that the audio data management technique is either one of First In First Out (FIFO) where the order in which the audio data (e.g. pending voice messages) are stored in the memory is the same order in which this data is played by the recorder, Last In Fast Out (LIFO) where the order in which the audio data (e.g. pending voice messages) are stored in the memory is in the opposite order in which this data is played by the recorder, or a combination of FIFO and LIFO.

More preferably, the audio recording device also includes a speech recognition mechanism for converting audio data that are played in response to the list instruction into text. Most preferably, the audio recording device also includes a display for displaying the text.

Preferably, the audio recording device also includes a mechanism for indicating the end of the statement. More preferably, this mechanism includes a push button. Also more preferably, this mechanism includes a switch.

In accordance with the present invention, there is further provided a method of organizing voice messages in a digital audio recorder, the method includes the steps of:

(a) storing a plurality of voice tags as audio data; (b) detecting a substantial similarity between a first portion of a statement spoken by a user and one of the voice tags; and (c) in accordance with the detected substantial similarity, storing a second portion of the statement as audio data in association with this voice tag.

Preferably, the second portion is a prefix and the first portion is a suffix. Alternatively, the second portion is a suffix and the first portion is a prefix. Optionally, at least one of the first portion and the second portion includes a middle portion of the statement.

Preferably, the method also includes the steps of: (c) storing a plurality of instruction commands as audio data; and (d) in accordance with the detected substantial similarity, if the second portion is substantially similar to one of the instruction commands then operating the digital audio recorder according to this one instruction command.

Preferably, the instruction commands include a delete instruction.

Preferably, the instruction commands include a new-folder instruction.

Preferably, the instruction commands include a list instruction. More preferably, the list instruction is for initiating playing of at least some of the audio data in chronological order. Also more preferably, the method also includes the step of converting audio data that are played in response to the list instruction into text. Most preferably, the method also includes the step of displaying the text.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawing, in which like numerals designate corresponding sections or elements throughout, and in which:

FIG. 1 is a block diagram of a Digital Audio Recorder device of the present invention;

FIG. 2 is a flow chart of a method of the present invention;

FIG. 3A shows the structure of a valid statement, received from a host, that includes a recognized voice tag (i.e. in the prefix of the statement) followed by a pending voice message (i.e. in the suffix of the statement);

FIG. 3B shows the structure of a valid statement, received from a host, that includes a recognized voice tag (i.e. in the prefix of the statement) followed by an instruction command (i.e. in the suffix of the statement); and

FIG. 3C shows the structure of a valid statement, received from a host, where a recognized voice tag is detected in the middle of the statement.

### DETAILED DESCRIPTION OF THE PREFERRED EMBODIMENTS

The present invention is a recording device implemented to store, in a memory, voice messages received from a user upon detecting a similarity between audio data received from the user and corresponding audio data previously stored in the memory.

The audio data herein refers to speech that is transformed into signals recognizable by a machine.

Note that in accordance with the present invention, the detection of a similarity between audio data received from the user and corresponding audio data previously stored in the memory requires utilizing pattern recognition methods only. Speech recognition is at all not required in the present invention, since there is no need to recognize what has been recorded by the user.

The recording device of the present invention is programmed to create a practically unlimited number of folders, each folder storing a number of corresponding pending voice messages that are received by the user.

A folder in the present invention represents a situation (e.g. where, when, etc.) a user is likely to want to be reminded of for doing things. Each folder is represented by a respective voice tag, i.e. an audio segment that is associated with this folder. The voice tags, stored in the memory in a table of voice tags for example, are preferably significantly different from one another and are identified according to their respective audio content using pattern recognition methods known in the art.

The audio data spoken by the user is defined herein as a “statement”.

The term “prefix of a statement” is used herein to mean the first syllable or syllables of a recorded audio statement (with length shorter than the full statement). The term “suffix of a statement” is used herein to mean the last syllable or syllables of a recorded audio statement (with length shorter than the full statement).

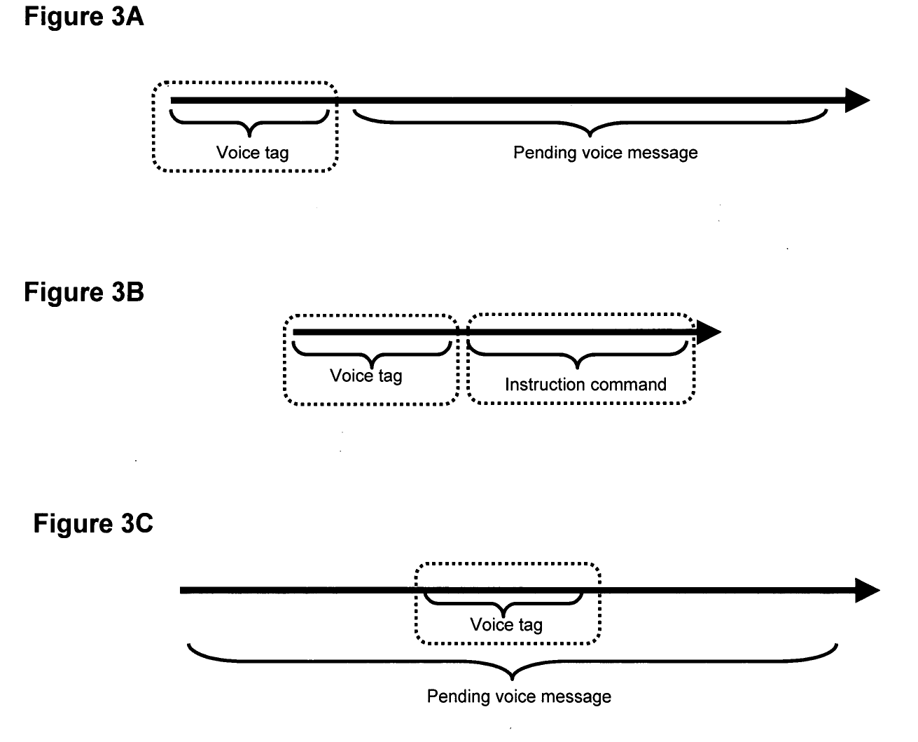

In accordance with a preferred embodiment (see FIG. 3A), a first portion of the statement typically includes a “voice tag” of a pre-defined folder previously stored in the memory and a second portion of the statement typically includes a new “pending voice message” that is to be stored in the memory, see FIG. 3A. Hence upon detecting a similarity between the first portion (i.e. voice tag) of the statement and corresponding audio data previously recorded in the memory, the second portion of the statement (i.e. the pending voice message) is stored, in the memory, in association with this voice tag.

Preferably but not limited to, the first portion of the statement is a bounding portion, such as the prefix or the suffix of the statement, and the second portion of the statement is a remainder portion, such as the suffix or the prefix of the statement, respectively. As an example, the statement—“Home Center buy 3 new shelves” includes the voice tag “Home Center” at its prefix and the new pending voice message “buy 3 new shelves” at its suffix. In this example, the first portion including the voice tag of a pre-defined folder previously stored in the memory is the prefix of the statement and the second portion including the new pending voice message is the suffix of the statement.

Alternatively, the first portion and/or the second portion of the statement include any portions of the statement, whether this portion is the prefix of the statement, the suffix of the statement or the middle of the statement. As an example, the statement—“when I go to Home Center buy 3 new shelves” includes the voice tag “Home Center” at its middle portion and the new pending voice message may include the whole statement “when I go to Home Center buy 3 new shelves”. In this example, the first portion including the voice tag of a pre-defined folder previously stored in the memory is the middle portion of the statement and the second portion including the new pending voice message is the entire statement itself.

In accordance with another embodiment (see FIG. 3B), the first portion of the statement includes a voice tag of a pre-defined folder and the second portion of the statement includes an instruction command. Typical instruction commands include a “list instruction” instructing to play all the pending voice messages stored in association with a respective folder, a “new-folder instruction” instructing to create a new folder in the memory, a “delete instruction” instructing to delete all or some pending voice messages from a respective folder, etc.

Note that as new folders are created separately and independently of any pre-defined folder, new pending voice messages are created in the memory in association with a respective folder.

In accordance with one embodiment, a statement including a voice tag and a new pending voice message to-be stored in the memory must be spoken by the user only after at least one “new-folder instruction” is initiated by the user.

In accordance with another embodiment, the recording device of the present invention is implemented with a group of built-in folders, so that a statement including a voice tag and a new pending voice message to-be stored in the memory can be spoken at any time, providing the voice tag represents a folder that is among this group of built-in folders.

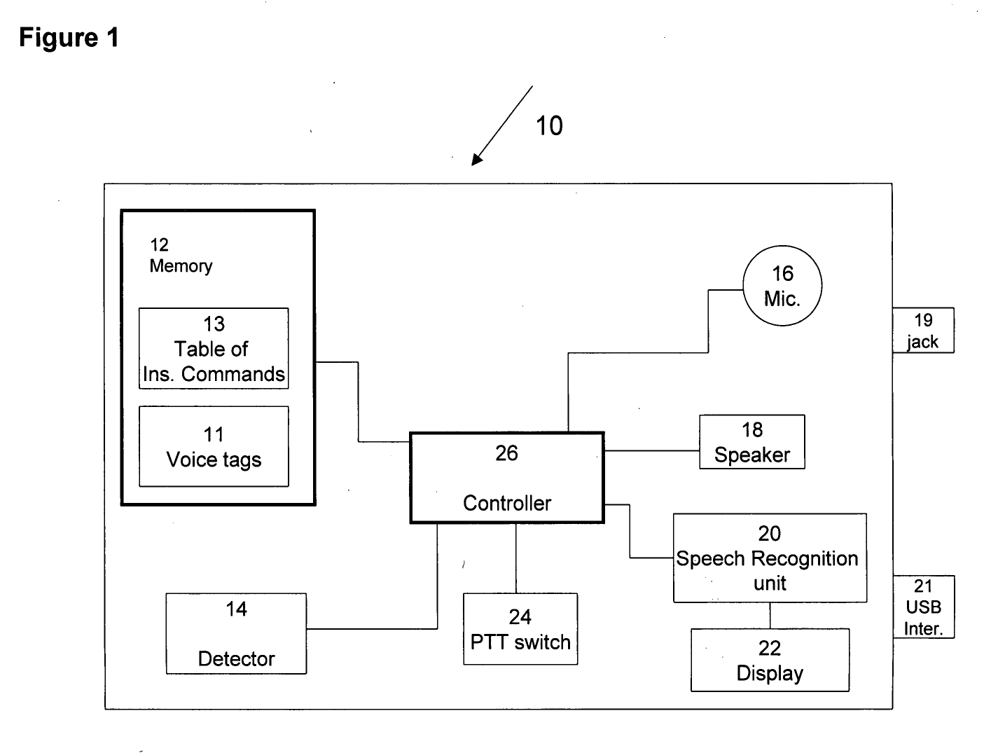

Referring to FIG. 1, there is shown a block diagram of a Digital Audio Recorder device 10 of the present invention. Digital Audio Recorder device 10 includes a controller 26 that is operative to store, in a memory 12, an effectively unlimited number of folders (i.e. more folders than a user is ever likely to need). Each folder is stored in association with a plurality of respective pending voice messages in Voice tags unit 11 of memory 12.

Preferably, the pending voice messages are stored, in association with the respective voice tags, in chronological order. The term “chronological order” is defined herein to mean that the management technique of the pending voice messages is either one of First In First Out (FIFO) where the order in which the audio data (e.g. pending voice messages) are stored in the memory is the same order in which this data is played by the recorder, Last In Fast Out (LIFO) where the order in which the audio data (e.g. pending voice messages) are stored in the memory is in the opposite order in which this data is played by the recorder, or a combination thereof of these techniques.

The instruction commands are stored in the memory, in a table of valid instruction commands 13 for example. Typical instruction commands include a “list instruction” instructing to play all the pending voice messages stored in association with a respective folder, a “new-folder instruction” instructing to create a new folder in the memory, a “delete instruction” instructing to delete all or some pending voice messages from a respective folder, etc.

For example, a verbal request to play all the pending voice messages of a respective folder can be made by a user via a statement, such as “Supermarket List” or “Grandma List”. In such case, the clause “supermarket” and the clause “grandma” are voice tags of two different folders and the clause “list” is a recognizable voice tag indicating to play all of the pending voice messages previously stored in the respective folders.

A detector 14 applying pattern recognition methods known in the art, as utilized in “Nokia Shorty™” (sold as a prepaid phone by Virgin Mobile Ltd.) for example, is provided for parsing audio data of a received statement into syllables and detecting an approximate similarity between a string of consecutive syllables (e.g. a prefix, a suffix) and a voice tag associated to a folder pre-recorded in memory 12. A well known pattern recognition method, for example, is the K-Nearest-Neighbor (KNN) algorithm, which is a method for classifying objects based on closest training examples in a feature space. The KNN algorithm utilizes new and updated examples of various known patterns in order to refine the decision thresholds between different patterns and improve the detection of future voice tags.

A microphone 16 is provided for receiving statements from a user and a built-in speaker 18 for playing the pending voice messages upon request. An earphone/headphone jack 19 and a USB interface 21 providing a PC link, for example, are also included.

In a preferred embodiment, a Speech Recognition unit 20 is provided for converting the pending voice messages into text and displaying the text upon a display 22. The conversion is applied using speech recognition methods known in the art, such as Dragon Dictate™, available from ScanSoft Inc., London, UK. Optionally, display 22 can be configured as a dual display further displaying the status of folders or remaining memory, for example.

Preferably, the Digital Audio Recorder device 10 of the present invention includes a Press-To-Talk (PTT switch 24 that must be pressed by the user upon recording, thereby preventing accidental recording of audio content.

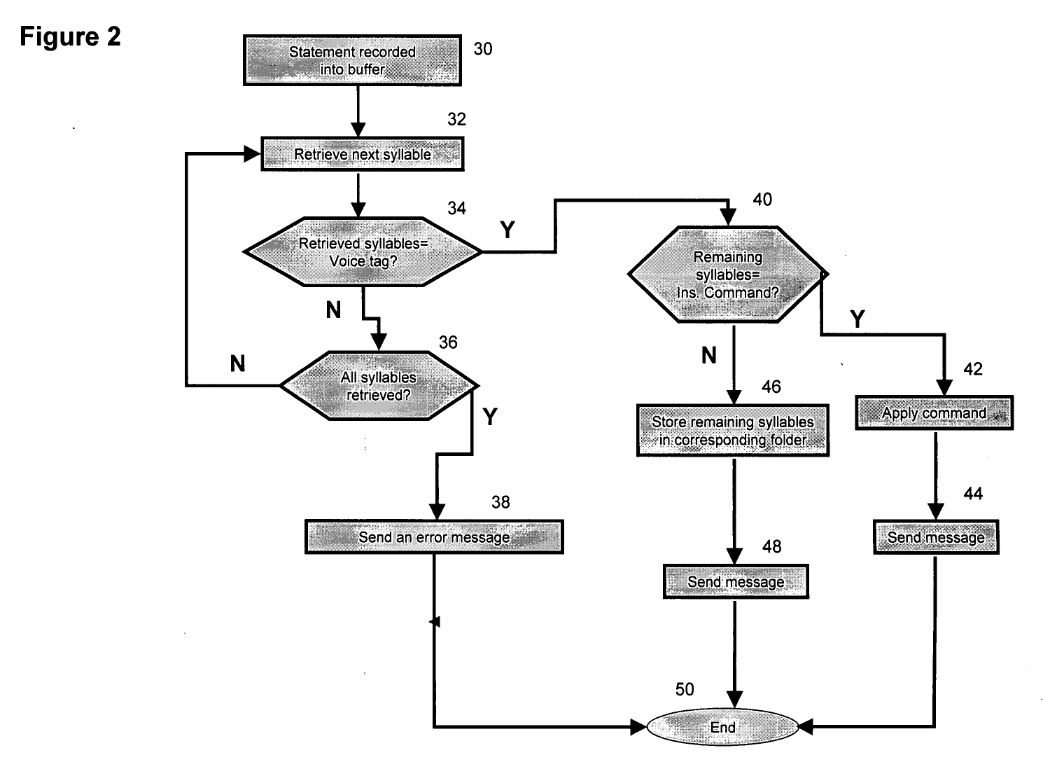

Referring to FIG. 2, there is shown a flowchart of a method of the present invention for operating the Digital Audio Recorder of FIG. 1 in response to receiving a statement from a user.

At the initial step 30, a user records a statement that is stored within a buffer of the DAR device. At the next step 32, a subsequent syllable is retrieved from the statement and concatenated with the previously retrieved syllables. The first time this step is applied only the first syllable of the statement is retrieved.

At step 34 it is determined whether the retrieved syllables (e.g. prefix of the statement) match a voice tag of a folder previously programmed to the device. In the affirmative case, the method proceeds to step 40. In the negative case, step 36, it is determined whether all the syllables of the statement are retrieved (i.e. such that the retrieved syllables include the whole statement).

In case not all the syllables are retrieved, the method returns to step 32, thereby retrieving the next syllable of the statement (such that the retrieved syllables include the syllables previously retrieved in earlier stages and the new syllable). However, in case all the syllables are retrieved, an error message is sent to the user (step 38) and the method comes to an end at step 50.

At step 40 it is determined whether the remaining syllables (e.g. suffix of the statement) match a valid instruction command.

In the affirmative case, the instruction command is applied at step 42 (typically with respect to the voice tag received by the user at the prefix of the statement), an acknowledgement message is sent to the user (step 44) and the method comes to an end at step 50. Note that new folders received by a “new-folder instruction” are created separately and independently from any pre-defined folders.

However in case the remaining syllables (e.g. suffix of the statement) do not match a valid instruction command pre-programmed in the device, then the remaining syllables of the statement are stored as a new pending voice message in association with the voice tag (e.g. the prefix of the statement) (step 48), a confirmation signal is sent to the user (step 48) and the method comes to an end at step 50.

Note that a valid statement is defined herein to include a voice tag (at the prefix) followed by a pending voice message or an instruction command (at the suffix).

However, the method of the present invention in accordance with FIG. 2 is provided as an example only, and defining a valid statement to include a pending voice message or an instruction command at the prefix followed by a voice tag at the suffix of the statement is also within the scope of the present invention.

Referring to FIG. 3A, there is shown the structure of a valid statement, received from a host, that includes a recognized voice tag (in the prefix of the statement as shown here) followed by a pending voice message (in the suffix of the statement).

Referring to FIG. 3B, there is shown the structure of a valid statement, received from a host, that includes a recognized voice tag (in the prefix of the statement as shown here) followed by an instruction command (in the suffix of the statement).

Referring to FIG. 3C, there is shown the structure of a valid statement, received from a host, including a pending voice message and a recognized voice tag, where the recognized voice tag is detected in the middle of the statement. According to FIG. 3C, the pending voice message includes the entire statement as received from the host.

According to some embodiments described herein above, a valid statement received from a user includes a voice tag followed by a pending voice message (see FIG. 3A) or an instruction command (see FIG. 3B). In other words, a valid statement is defined to include a voice tag in the prefix and a pending voice message or an instruction command in the suffix. In accordance with other embodiments of the present invention, a valid statement is further defined to include a pending voice message followed by a voice tag (i.e. such that the prefix is the pending voice message and the suffix is the voice tag), or an instruction command followed by a voice tag (i.e. such that the prefix is the instruction command and the suffix is the voice tag). Furthermore, a valid statement may include a voice tag and/or an instruction command at the middle of the statement and are not limited to the prefix or the suffix (see FIG. 3B).

It should be noted that the present invention relates to an audio recording device. Preferably, the method of the present invention is implemented within a mobile phone. Furthermore, it can be understood that other implementations are possible within the scope of the invention. Thus the scope of the present invention includes any recording device capable of selectively storing audio data received from a user in response to detecting a similarity with voice tags previously stored in the recording device.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

1. An audio recording device comprising:
(a) a memory wherein are stored audio data including a plurality of voice tags;
(b) a detector operative to produce a signal upon detection of a substantial similarity between a first portion of a statement spoken by a user and one of said voice tags; and
(c) a controller, operative in accordance with said signal produced by said detector, to store, in said memory, a second portion of said statement as audio data in association with said one voice tag.

2. The audio recording device of claim 1, wherein said second portion is a prefix and said first portion is a suffix.

3. The audio recording device of claim 1, wherein said second portion is a suffix and said portion is a prefix.

4. The audio recording device of claim 1, wherein at least one of said first portion and said second portion includes a middle portion of said statement.

5. The audio recording device of claim 1, wherein said audio data, stored in said memory, include instruction commands.

6. The audio recording device of claim 5, wherein said detector is further operative to detect a substantial similarity between said first portion of said statement and one of said instruction commands, and wherein said controller is further operative, in accordance with said signal produced by said detector, to apply said one instruction command in association with said second portion of said statement.

7. The audio recording device of claim 5, wherein said instruction commands include a delete instruction.

8. The audio recording device of claim 5, wherein said instruction commands include a new-folder instruction.

9. The audio recording device of claim 5, wherein said instruction commands include a list instruction.

10. The audio recording device of claim 9, wherein said list instruction is for initiating playing of at least some of said audio data in chronological order.

11. The audio recording device of claim 1 further comprising a mechanism for indicating an end of said statement.

12. The audio recording device of claim 11, wherein said mechanism includes a push button.

13. The audio recording device of claim 11, wherein said mechanism includes a switch.

14. A method of organizing voice messages in a digital audio recorder, the method comprising the steps of:
(a) storing a plurality of voice tags as audio data;
(b) detecting a substantial similarity between a first portion of a statement spoken by a user and one of said voice tags; and
(c) in accordance with said detected substantial similarity, storing a second portion of said statement as audio data in association with said one voice tag.

15. The method of claim 14, wherein said second portion is a prefix and said first portion is a suffix.

16. The method of claim 14, wherein said second portion is a suffix and said first portion is a prefix.

17. The method of claim 14, wherein at least one of said first portion and said second portion includes a middle portion of said statement.

18. The method of claim 14 further comprising the steps of:
(d) storing a plurality of instruction commands as audio data; and
(e) in accordance with said detected substantial similarity, if said second portion is substantially similar to one of said instruction commands: operating the digital audio recorder according to said one instruction command.

19. The method of claim 18, wherein said plurality of instruction commands include a delete instruction.

20. The method of claim 18, wherein said plurality of instruction commands include a new-folder instruction.

21. The method of claim 18, wherein said plurality of instruction commands include a list instruction.

22. The method of claim 21, wherein said list instruction is for initiating playing of at least some of said audio data in chronological order.
